(19) United States
(12) Patent Application Publication
(10) Pub. No.: US 2020/0174323 A1
(43) Pub. Date: Jun. 4, 2020

(54) PHOTOSTABLE ALIGNMENT LAYER VIA BLEACHING

(71) Applicants: KENT STATE UNIVERSITY, Kent, OH (US); MASSACHUSETTS INSTITUTE OF TECHNOLOGY, Cambridge, MA (US)

(72) Inventors: Colin McGinty, Cleveland, OH (US); Philip J. Bos, Hudson, OH (US); Valerie A. Finnemeyer, Kent, OH (US); Robert K. Reich, Tyngsborough, MA (US); Harry R. Clark, Townsend, MA (US); Shaun R. Berry, Chelmsford, MA (US)

(73) Assignees: Kent State University, Kent, OH (US); Massachusetts Institute of Technology, Cambridge, MA (US)

(21) Appl. No.: 16/614,872

(22) PCT Filed: May 21, 2018
(86) PCT No.: PCT/US2018/033590

§ 371 Date: Nov. 19, 2019

Related U.S. Application Data
(60) Provisional application No. 62/508,406, filed on May 19, 2017.

(51) Int. Cl. G02F 1/1337; C09K 19/60; C09K 19/56

(52) U.S. Cl. CPC G02F 1/133788; C09K 19/601; G02F 2001/133726; G02F 1/133711; G02F 2202/04; C09K 19/56

(57) ABSTRACT

A method for producing a photostable reactive mesogen alignment layer includes infusing an anisotropic dye into a microcavity so as to coat the an surface of the microcavity with the anisotropic dye; illuminating the anisotropic dye with polarized light so as to form an anisotropic dye layer aligned with respect to the inner surface of the microcavity; infusing a reactive mesogen and the liquid crystal material into the microcavity; illuminating the reactive mesogen at a wavelength selected to cause polymerization of the layer of the reactive mesogen so as to form a polymerized reactive mesogen layer; aligning the liquid crystal material with respect to the anisotropic dye layer; and bleaching the anisotropic dye layer.

This application claims the benefit of U.S. Provisional Application No. 62/508,406, filed May 19, 2017 and titled “PHOTOSTABLE ALIGNMENT LAYER VIA BLEACHING”, which is hereby incorporated by reference in its entirety.

### STATEMENT REGARDING FEDERALLY SPONSORED RESEARCH

This invention was made with government support under Contract No. FA8721-05-C-0002 awarded by the United States Air Force. The government has certain rights in the invention.

### INCORPORATION BY REFERENCE

United States Patent Application Publication No. US 2016/0109760 A1, published Apr. 21, 2016, is incorporated by reference herein in its entirety.

### BACKGROUND

Liquid crystals (LCs) are materials that flow like liquids with crystalline solid-like ordered molecules that align and orient along a particular direction in the presence (or absence) of an electric field. These materials are widely used to manipulate the polarization and transmission of light, including in liquid crystal displays (LCDs). In an LCD, an LC layer is usually formed by aligning the LC material with respect to a pair of substrates and sandwiching the substrates between a pair of crossed polarizers. Applying an electric field to the LC layer causes the LC to align or twist, thereby allowing or blocking the incident light.

Typically, the LC material is aligned to the substrate with an alignment layer. The alignment layer is typically applied through a standard spin-coating method with a layer thickness on the order of several hundred nanometers. This layer orients the LC molecules, which often have an oblong shape, along a surface of the substrate, which is typically transparent glass or plastic. This type of alignment causes most or all of the LC material to form a “single crystal” that can be re-oriented using an electric field. Absent this alignment layer, the liquid crystals would behave as a “polycrystalline” material; that is, the LC layer would form smaller LC domains, each containing molecules aligning in an orientation different from those of other LC domains. Light passing through a polycrystalline LC layer undergoes non-uniform scattering and random variation in light transmission, producing diffused, low-intensity lighting.

The most commonly used method for aligning liquid crystal is the mechanical rubbing of polyimide layers deposited on glass substrates. While rubbed polyimide provides strong anchoring at the surface, there are several drawbacks and limitations to this method. First, the process involves a high temperature baking step that limits use of flexible substrates. Second, mechanical rubbing requires precise control and expensive equipment. Third, the rubbing step allows for potential contamination with debris as well as buildup of static charge. Fourth, the alignment provided by the polyimide alignment layer is not microscopically uniform, resulting in low contrast between the bright and dark states.

Photoalignment, where the preferred direction of the alignment layer is controlled by the polarization of light, is the most commonly proposed alternative to rubbing methods. The three main mechanisms of photoalignment are photo-polymerization, photo-degradation, and photo-reorientation. Photo-polymerization involves crosslinking in cinnamoyl side-chain polymers. Photo-polymerization, however, does not allow for the generation of a pretilt in the alignment. Additionally, the alignment layers generated using this method have been shown to have low anchoring energies.

Photo-degradation involves the selective decomposition of polyimides. Since this process still involves the use of polyimides, there is still a high temperature bake involved which limits the scope of applications. Additionally, the process leaves open chemical bonds which can lead to image sticking problems in display devices.

Finally, photo-reorientation involves the reorientation of molecules in an azo dye film by using polarized light. This method has the advantages of generating an alignment film with both high order parameter and anchoring energy. Unfortunately, these azo dye films are not stable to subsequent exposures to polarized light meaning the preferred alignment direction of the film can change.

Three main solutions have been proposed for addressing the instability of azo dye films to subsequent exposures to polarized light. The first method involves the use of azo dyes with functionalized end groups. These dyes can be aligned, and then polymerized to ‘lock-in’ the induced alignment—the result is a highly uniform, thermally stable alignment layer. However, polymerizable dyes provide a lower anchoring energy than their non-polymerizable counterparts. Additionally, this method involves the synthesis of specialty materials. The second method involves the use of a reactive mesogen layer to passivate the underlying azo dye film. The reactive mesogen passivation layer is deposited by spin coating on the film. This adds an extra processing step that can limit the potential scope of applications for this method. Additionally, while the use of the passivation layer improves the stability of the film to polarized light, the data presented on this topic is quite limited. The final method involves spincoating a mixture of liquid crystal polymer and azodye onto a substrate followed by an exposure to both align and polymerize the composite film. However, the details of the mixture required for the composite film are unclear and are very sensitive to the concentration of photoinitiator, for example.

Overall, photoalignment is a common alternative to rubbing methods which have well documented drawbacks. Photo-reorientation of azo dyes is the most promising mechanism of photoalignment because of its high order parameter and anchoring energy but has the enormous drawback of instability to subsequent exposures to polarized light. Solutions proposed to address this problem have resulted in either the lowering of the anchoring energy or the addition of processing steps which can limit the scope of applications.

Conventional photo-aligned layers tend to degrade when exposed to light or heat, making them unsuitable for many applications, including displays and thermal sensing. Of particular importance for photonic applications is stability under exposure to light of random polarization states. Also, in the case of photonic devices, the light intensity which the device is subjected to can be quite high, enhancing the probability of device failure if the stability is low. It should be noted that for many applications of azo dye alignment layers, the “rewriteability” of these materials is emphasized as a positive attribute. However, in the case of photonic devices where the azo dyes are desired for their high anchoring energy, rewriteability is problematic.

### BRIEF DESCRIPTION

The present disclosure relates to methods for “locking in” desired alignment in liquid crystal cells via bleaching (e.g., photobleaching). The cells, devices containing the cells, and systems for performing the methods are also disclosed.

Disclosed, in various embodiments, is a method of aligning liquid crystal material to an inner surface of a microcavity, the method comprising: infusing an anisotropic dye into the microcavity so as to coat the interior surface of the microcavity with the anisotropic dye; illuminating the anisotropic dye with polarized light so as to form an anisotropic dye layer aligned with respect to the inner surface of the microcavity; infusing a reactive mesogen and the liquid crystal material into the microcavity; illuminating the reactive mesogen at a wavelength selected to cause polymerization of the layer of the reactive mesogen so as to form a polymerized reactive mesogen layer; aligning the liquid crystal material with respect to the anisotropic dye layer; and bleaching the anisotropic dye layer.

In some embodiments, infusing the anisotropic dye comprises infusing at least one of an azo dye or a dye substantially similar to an azo compound.

The infusing the anisotropic dye may comprise: disposing the microcavity in a dye solution comprising the anisotropic dye and a solvent; and heating the microcavity so as to evaporate the solvent.

In some embodiments, the process comprises infusing reactive mesogens dissolved at low concentration in liquid crystals.

The infusing the reactive mesogen and the liquid crystal material may comprise: infusing a mixture of the reactive mesogen, the liquid crystal material, and a photoinitiator into the microcavity.

In some embodiments, the mixture of the reactive mesogen, the liquid crystal material, and the photoinitiator has a weight ratio of reactive mesogen to liquid crystal material to photoinitiator of about 1.35 to about 98.50 to about 0.15.

In some embodiments, the mixture of the reactive mesogen, the liquid crystal material when ZLI-4792, and the photoinitiator has a weight ratio of reactive mesogen to liquid crystal material to photoinitiator of about 0.3 to about 99.55 to about 0.15

The method may further include: heating and mixing the mixture of the reactive mesogen, the liquid crystal material, and the photoinitiator prior to infusing the mixture into the microcavity.

In some embodiments, infusing the reactive mesogen and the liquid crystal material further comprises: allowing the reactive mesogen to separate from the liquid crystal material before illuminating the reactive mesogen.

The illuminating the reactive mesogen may further comprise: applying at least one voltage across at least a portion of the microcavity while illuminating the reactive mesogen so as to lock in alignment of the polymerized reactive mesogen layer with respect to the anisotropic dye layer.

In some embodiments, applying the at least one voltage comprises: applying a first voltage across a first portion of the microcavity and a second voltage across a second portion of the microcavity so as to create spatially varying alignment of the anisotropic dye to the liquid crystal material.

In some embodiments, the polymerized reactive mesogen layer may have a thickness of less than approximately 100 nanometers.

In some embodiments, the polymerized reactive mesogen layer may have a thickness of less than approximately 10 nanometers.

In some embodiments, the method further includes: infusing a photoinitiator into the microcavity before illuminating the reactive mesogen with ultraviolet light.

The photoinitiator may be Irgacure 651.

In some embodiments, the anisotropic dye layer has a thickness of less than or equal to about 3 nanometers. The thickness may be about 3 nanometers estimated by the Beer-Lambert law.

The bleaching may be performed by exposing the anisotropic dye layer to light at an intensity of at least 150 mW/cm².

In some embodiments, the bleaching is performed by exposing the anisotropic dye layer to light at an intensity of at least 200 mW/cm².

The bleaching may be performed by exposing the anisotropic dye layer to high intensity light for a duration of at least 36 hours.

In some embodiments, the bleaching is performed by exposing the anisotropic dye layer to high intensity light for a duration of at least 48 hours.

Disclosed, in other embodiments, is a method of aligning a liquid crystal material to an inner surface of a microcavity, the method comprising: infusing an anisotropic dye into the microcavity so as to coat the interior surface of the microcavity with the anisotropic dye; illuminating the anisotropic dye with polarized light so as to form an anisotropic dye layer aligned with respect to the inner surface of the microcavity; infusing a reactive mesogen and the liquid crystal material into the microcavity; illuminating the reactive mesogen at a wavelength selected to cause polymerization of the layer of the reactive mesogen so as to form a polymerized reactive mesogen layer; aligning the liquid crystal material with respect to the anisotropic dye layer; and bleaching the anisotropic dye layer; wherein the bleaching is performed by exposing the anisotropic dye layer to light at an intensity of at least 150 mW/cm²; and wherein the bleaching is performed by exposing the anisotropic dye layer to high intensity light for a duration of at least 36 hours.

Disclosed, in further embodiments, is a method of aligning a liquid crystal material to an inner surface of a microcavity, the method comprising: infusing an anisotropic dye into the microcavity so as to coat the interior surface of the microcavity with the anisotropic dye; illuminating the anisotropic dye with polarized light so as to form an anisotropic dye layer aligned with respect to the inner surface of the microcavity; infusing a reactive mesogen and the liquid crystal material into the microcavity; illuminating the reactive mesogen at a wavelength selected to cause polymerization of the layer of the reactive mesogen so as to form a polymerized reactive mesogen layer; aligning the liquid crystal material with respect to the anisotropic dye layer; and bleaching the anisotropic dye layer; wherein the bleaching is performed by exposing the anisotropic dye layer to light at an intensity of at least 200 mW/cm²; and wherein the bleaching is performed by exposing the anisotropic dye layer to high intensity light for a duration of at least 48 hours.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1A is a cross-sectional view of a microcavity disposed within a substrate to hold liquid crystal material.

FIG. 1B is an illustration of the microcavity of FIG. 1A filled with a mixture of materials in preparation for photoaligning a liquid crystal material.

FIG. 1C is an illustration of the liquid crystal microcavity of FIGS. 1A and 1B with photoalignment in place.

FIG. 1D is a top-view of the microcavity of FIG. 1C.

FIG. 1E is an exemplary illustration of a microcavity disposed on an elevated platform filled with liquid crystal and photoaligning materials according to another embodiment.

FIG. 2A is a flow chart illustrating an exemplary fabrication process flow diagram for creating a versatile alignment layer in a liquid crystal device via mixing reactive mesogen and liquid crystal prior to infusing into a microcavity.

FIG. 2B is a flow chart illustrating an exemplary fabrication process flow diagram for creating a versatile alignment layer in a liquid crystal device via infusing reactive mesogen and then infusing liquid crystal into a microcavity.

FIG. 2C is a flow chart illustrating an exemplary fabrication process flow diagram for forming an azo dye layer in a microcavity.

FIG. 2D is a graph of the absorption spectrum of Brilliant Yellow dye.

FIG. 2E is a flow chart illustrating an exemplary fabrication process flow diagram for form a reactive mesogen layer within a microcavity.

FIG. 3 is a flow chart illustrating a more general method in accordance with some embodiments of the present disclosure.

FIG. 4A is an illustration of a filled microcavity containing a mixture of liquid crystal materials and reactive mesogen monomers, which preferentially localizes near the microcavity surfaces.

FIG. 4B is an illustration of the filled microcavity in which the liquid crystal is re-oriented under applied voltage.

FIG. 4C is an illustration of the filled microcavity in which monomers are crosslinked under ultraviolet (UV) illumination to lock in the orientation of liquid crystal.

FIG. 4D is an illustration of the filled microcavity with “oriented” liquid crystal (without an applied voltage).

FIG. 5 includes photographs of a stabilized cell seen before (left) and after (right) one month of photostability testing between crossed polarizers. The dark state of the sample was preserved indicating no change in the liquid crystal alignment.

FIG. 6 is a graph showing the angular dependence of the absorbance of the Brilliant Yellow film before (solid) and after (dashed) 5 days of photostability testing. The designation of near and far in the legend refer to the BY film that was on the substrate nearest or furthest from the lifetest exposure.

FIG. 7 includes photographs of a control cell filled with pure E7 seen between crossed polarizers before (left) and after (right) 48 hours of exposure to intense unpolarized light. Prior to exposure a uniform dark state is present—no such state existed after.

FIG. 8 includes photographs of a cell filled with RM 257 and E7 mixture seen between crossed polarizers before (left) and after (right) 48 hours of exposure to intense unpolarized light. A uniform dark state is present before and after exposure.

FIG. 9 includes graphs of transmission (detector voltage) versus viewing angle measurement for the cell pictured in FIG. 8 before (left) and after (right) 48 hours of intense unpolarized exposure. The fact that the curves share the same shape and symmetry before and after exposure indicates no pretilt was generated and the liquid crystal alignment was unaltered.

FIG. 10 is a graph showing the angular dependence of the absorbance of the Brilliant Yellow film before (solid) and after (dashed) 48 hours of intense unpolarized exposure. The magnitude of the absorbance after bleaching is smaller for all polarizations than the smallest absorbance measurement before bleaching. All measurements were made at the maximum absorbance of the BY film (˜408 nm).

FIG. 11 is a chemical formula of a reactive mesogen material which may be used in accordance with some embodiments of the present disclosure.

FIG. 12 includes photographs of a cell filled with RM 257 and ZLI-4792 mixture seen between crossed polarizers before (left) and after (right) 48 hours of exposure to intense unpolarized light. A uniform dark state is present before and after exposure.

FIG. 13 includes photographs of a cell filled with the reactive mesogen of FIG. 11 and ZLI-4792 mixture seen between crossed polarizers before (left) and after (right) 48 hours of exposure to intense unpolarized light. A uniform dark state is present before and after exposure.

### DETAILED DESCRIPTION

A more complete understanding of the systems, methods, and products disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

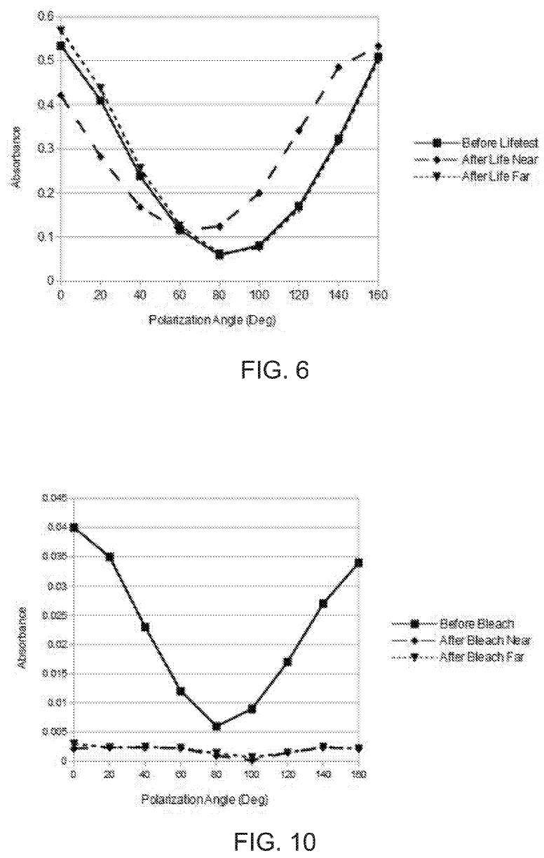

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. The materials, methods, and articles disclosed herein are illustrative only and not intended to be limiting. For example, RM 257 mixed with E7 is discussed throughout this application, particularly in the Examples section. However, other RM structures such as the structure of FIG. 11 and other liquid crystal materials such as ZLI-4792 were also considered. Additionally, microcavities with a single port in a substrate are discussed throughout the specification. However, the systems and methods of the present disclosure can be applied to other cell structures also.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein, the term “azo dye” refers to a dye containing an azo compound. In some embodiments, the azo compound has the general formula

R—N═N—R′

wherein R and R′ can be aryl or alkyl. The aryl or alkyl may be substituted.

As used herein, “Brilliant Yellow” refers to an azo dye having the following structure:

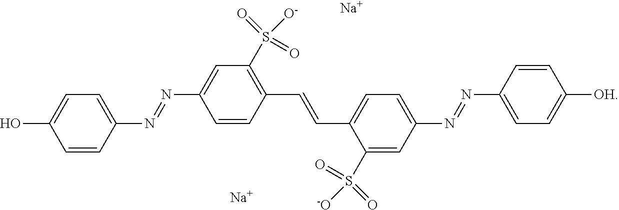

As used herein, “RM 257” refers to a reactive mesogen having the following structure:

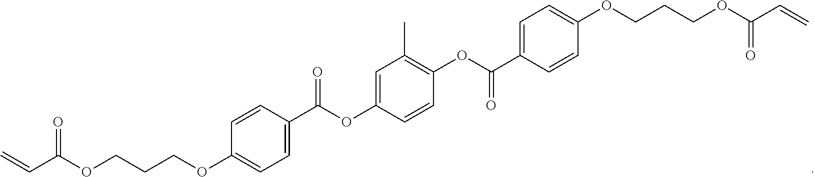 [SMILES: C=CC(=O)OCCCOc1ccc(C(=O)Oc2ccc(OC(=O)c3ccc(OCCCOC(=O)C=C)cc3)c(C)c2)cc1]

As discussed above, conventional photoalignment involves forming a layer of photo-alignable material, such as a dichroic dye (a dye that absorbs light anisotropically, such as Brilliant yellow or another azo dye), on the substrate surface. A thin coating of the azo dye is placed on the glass or electrode surface, and then blue polarized light is shined upon it. The polarized light aligns the azo dye molecules, which tend to be oblong, perpendicular to the polarization in a semi-permanent position. Unfortunately, azo dye layers are not stable enough for most applications as they tend to degrade when exposed to visible light.

Forming a layer of polymerized reactive mesogen or another suitable material over the azo dye layer results in the polymer layer functioning as the liquid crystal alignment layer with the azodye film free to reorient beneath it. The reactive mesogen forms a polymerized layer which, when polymerized, enforces the existing liquid crystalline alignment rather than disrupting it. In other words, acting as an intermediary, the reactive mesogen aligns with the azo dye layer, and polymerizing of the reactive mesogen subsequent fixes this alignment. The polymerized and aligned reactive mesogen, in turn, aligns itself with the liquid crystal material. Subsequent bleaching eliminates the polarization sensitivity of the azodye absorption and thus eliminates its ability to reorient under further exposure to polarized light. This alignment approach can be applied after almost all fabrication processing steps and can be utilized in any application involving cell geometry with minimal fill-port access.

Using reactive mesogen in photoaligning the azo dye can be applied to non-planar surfaces, such as the inner wall surfaces inside microcavities. The reactive mesogen dissolves in liquid crystal materials at low concentrations, but can become slightly immiscible in the base liquid crystal when the reactive mesogen polymerizes. In some cases, the process for mixing the reactive mesogen with the liquid crystal can be controlled such that the reactive mesogen deposits out of solution onto the microcavity surface(s). When the reactive mesogen polymerizes, the polymer network usually agglomerates at the surface because it is much more concentrated than the bulk liquid crystal/reactive mesogen mixture; reactive mesogen, however, has limited polymerization in the bulk liquid crystal/reactive mesogen mixture because the mixture is usually diluted. Moreover, photostability tests have shown the reactive mesogen on the photoalignment dye layer is very stable over temperature and exposure compared to samples without the reactive mesogen.

Reactive mesogen-stabilized photo-alignment layers can be used in a variety of emerging photonics applications and devices, including but not limited to ring resonators, lenses, photonic crystal fibers, and uncooled thermal imagers. These imagers comprise high performance, large format, arrays of thermal imaging pixels to detect long wavelength infrared (LWIR) light. In this particular application, aligning the LC material inside micron-sized thermal imaging pixels can no longer be applicable using conventional rubbing technique, as it will be exceeding difficult to apply rubbing alignment technique to any miniature platforms at the micron scale. Other applications include curved displays, planar displays, etc. For example, in large-area applications, the azo dye and reactive mesogen could be sprayed onto the substrate and illuminated as described below to align the azo dye and polymerize the reactive mesogen.

The following sections describe techniques for creating photoalignment layers by infiltrating a dissolved photo-definable dye into microcavities through a single micron-sized opening. Also presented is a process to stabilize the photoalignment layer by infiltration into the microcavity of a reactive mesogen that has been pre-mixed into host LC materials. The layers generated by the process disclosed in this application are relatively thin (e.g., <100 nm thick) and do not exhibit a large degree of light scattering.

Using the method, new unexpected and useful results have been discovered. The systems and methods of the present disclosure may produce a device that is more stable, when thinner layers of azo dye are used. The azo dye layer can be subsequently exposed with high intensity light to cause it to become non-absorbing, while at the same time the original alignment is well maintained, and therefore remove any possibility of further degradation of the alignment of the host LC by further optical exposure.

The systems and methods of the present disclosure allow the effect of photo-alignment to be “turned off” after the desired alignment is achieved, and therefore the alignment is completely stable to subsequent exposures of light.

This approach offers several advantages to rubbing methods, as well as other photoalignment methods. First, cheap and commercially available materials can be used. Second, because the reactive mesogen is dissolved in the liquid crystal and not spun down, the methods can be applied to other geometries besides the typical ‘sandwich cell’. Third, by eliminating the polarization sensitivity of the azo dye film through bleaching, questions about the stability of the liquid crystal alignment upon exposure to polarized light have been eliminated. Fourth, tunable and arbitrarily large pretilt can be achieved by polymerizing the reactive mesogen with a voltage applied across the cell.

In some embodiments, a method for producing a reactive mesogen (e.g., RM 257) alignment layer utilizes photoalignment materials. This alignment layer is stable to subsequent exposures to polarized light because the sensitivity of the dye film to polarization has been eliminated. The process has exhibited the most complete demonstration of stability to subsequent exposures to polarized light both with and without the bleaching step.

A technique is described herein for introducing a stable azo dye photoalignment to confined microcavities with a single entry/exit port. In this method, the azo dye photoalignment layer is introduced to the cell and illuminated with polarized light to form a first alignment layer. A polymer network is then introduced into the cell in the form of a reactive mesogen. In some embodiments, the reactive mesogen is mixed at low concentration with the liquid crystal, then phase separated to the surfaces and polymerized to form a layer of polymerized reactive mesogen that aligns the liquid crystal to the azo dye layer. Next, the dye is bleached. This simple method offers high stability against subsequent exposure to both heat and light. Beneficially, this method also avoids the requirements of strict process control; both the photoalignment dye and the photoinitiator for the polymerization process may absorb in the same wavelength range, in some cases without degradation of the process or decrease in yield.

Previously, the infiltration of reactive mesogen into the cell along with the liquid crystal has been proposed for creating customizable pretilt which can be patterned throughout the cell. However, the reactive mesogen used to create the pretilt modified a well-known stable alignment layer (polyimide), not an azo dye layer, so the reactive mesogen was not expected to stabilize or improve the quality of a weak or easily degraded or poor quality alignment layer.

The proposed method for azodye alignment has many advantages over previous alignment methods. These advantages include low cost, simple manufacturing without the need for expensive and difficult-to-control rubbing processes, no high temperature bakes that limit substrate material selection, and the ability to photopattern the alignment axis and pretilt.

The process of creating a stable azo dye photoalignment layer in confined microcavities may begin with the application of the azo dye layer. A dye solution is prepared in which the azo or other dichroic dye is mixed into an appropriate solvent at low concentrations. The microcavities may be fully submerged in this solution and allowed to soak; this soaking process may provide sufficient time for the dye solution to fully infiltrate the cavities, which will depend on both cavity volume and the area of the entry/exit port. Vacuum-filling of the cavities could also be used if there is no concern about evaporation of the solvent in vacuum.

Next, the microcavity sample is removed from the solution and residue on outer surface removed. The sample should then be immediately placed in an oven or on a heat stage at or near the boiling point of the solvent to force quick evaporation of all solvent and deposition of a uniform dye layer through the microcavities. From this point, processing of the photoalignment layer should continue in the typical fashion; the sample is irradiated with polarized light of an appropriate wavelength to effectively align the dye layer.

A liquid crystal mixture is also prepared containing a low concentration of reactive mesogen along with a photoinitiator. If preferred, a thermal initiator may also be used. Appropriate selection of liquid crystal and reactive mesogen may ensure that the reactive mesogen in the liquid crystal will phase separate as desired. For example, when a cyanobiphenyl such as E7 is considered, the concentration of reactive mesogen required to provide stable photoalignment was 1.5% by weight. When a fluorinated material such as ZLI-4792 was considered, as little as 0.3% RM 257 by weight provided stable alignment.

The mixture is then heated to above the isotropic transition temperature of the liquid crystal and mixed using either vortex mixing or sonication. Once mixed, the solution can be introduced into the cell in any desired manner. The mixture may then be phase separated, allowing the reactive mesogen to aggregate on the cell surfaces. This can be done by, e.g., by passively allowing the mixture time to separate or taking active measures (e.g., applying a low frequency, high voltage to assist in driving the reactive mesogen to the cell surfaces). In this case, the liquid crystalline and reactive mesogen materials may be chosen such that ions in the solution will preferentially associate with the reactive mesogen rather than the liquid crystal; the current will assist in driving those molecules associated with ions to the surface.

After phase separation, the cell is exposed to an appropriate wavelength to activate the photoinitiator (or temperature to activate the thermal initiator). The use of low intensity for this exposure is recommended to allow slow migration of the reactive mesogen as the polymer network begins to form and to avoid any negative effects on the underlying alignment layer. This polymerization can occur either with or without applied voltage; the application of voltage results in a liquid crystal pretilt.

After bleaching, the alignment originally imposed by the photoalignment layer (the azo dye layer) is locked in by the polymer network (the polymerized reactive mesogen layer) with or without additional pretilt. Any condition which would cause degradation of the photoalignment layer will now not cause degradation of the liquid crystal alignment in the cell or microcavities.

In some embodiments, the bleaching is performed by exposing the cell to high intensity light. The exposure may last from about 24 to about 72 hours, including from about 36 to about 60 hours and about 48 hours. In some embodiments, the exposure lasts at least 24 hours, at least 36 hours, or at least 40 hours. The intensity may be from about 100 mW/cm² to about 300 mW/cm², including from about 150 mW/cm² to about 250 mW/cm² and about 200 mW/cm². In some embodiments, the intensity is at least 100 mW/cm², at least 150 mW/cm², or at least 200 mW/cm². In some embodiments, the light has a wavelength of from about 300 nm to about 600 nm, including from about 350 nm to about 550 nm, from about 375 nm to about 500 nm, from about 400 nm to about 470 nm, from about 420 nm to about 450 nm, from about 430 nm to about 440 nm, and about 435 nm.

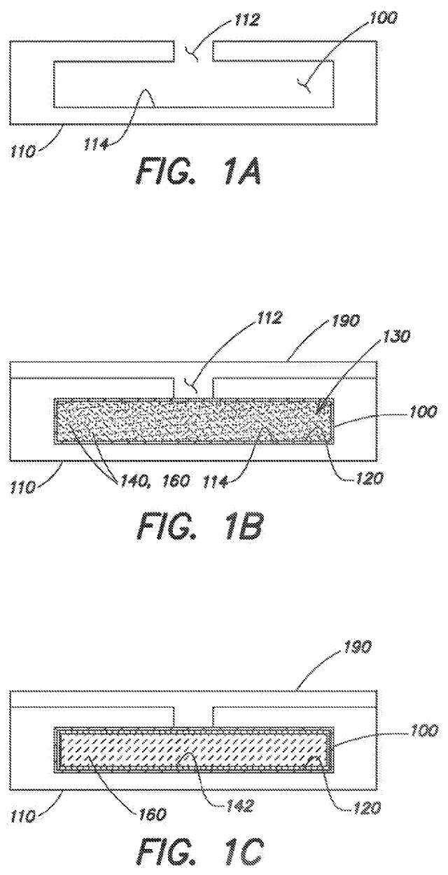

FIG. 1A shows an exemplary microcavity structure 100 disposed in a substrate 110, with inner surfaces 114 and a single entry/exit port 112. (Other embodiments of the microcavity may have two or more ports for use as separate entry and ports). The substrate 110 in FIG. 1A can be made of any material(s), including but not limited to silicon, silicon oxide, silicon nitride, etc. Depending on the materials of the substrate 110, the microcavity 100 within the substrate 110 can be produced using conventional photolithography techniques including, but not limited to wet-etching; dry-etching; sputter etching; reactive ion etching (RIE), including plasma, radio frequency, and deep RIE; vapor-phase etching; etc. In some embodiments, the shapes of the microcavity 100 can be as follows: the cross-sectional shape of the microcavity 100 can include circle, oval, triangle, square, rectangle, trapezium, diamond, rhombus, parallelogram, pentagon, hexagon, heptagon, octagon, or any other polygonal or 2-dimensional shapes. Possible volumetric shapes of the microcavity 100 include, but are not limited to rectangular prism (like a match-box type aspect ratio), triangular prism, pentagonal prism, hexagonal prism, and any polygonal prism, pyramid, tetrahedron, wedge, cube, sphere, cone, cylinder, torus, and any possible aspect ratio of ellipsoids and ellipsoidal dimensions.

The dimensions of the microcavity 100 can range from about 10 μm to about 1 mm (e.g., about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about, 120 μm, about 140 μm, about 160 μm, about 180 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, and about 1000 μm).

Similarly, the size of the port 112 can range from about 1 μm to about 500 μm, depending on the size of the microcavity 100 (e.g., about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about, 120 μm, about 140 μm, about 160 μm, about 180 μm, about 200 μm, about 250 μm, about 300 μm, about 350 μm, about 400 μm, about 450 μm, about 500 μm). The shape of the opening of port 112 (2-dimensional shape) can include circle, oval, triangle, square, rectangle, trapezium, diamond, rhombus, parallelogram, pentagon, hexagon, heptagon, octagon, or any other 2-dimensional shape.

Since the microcavity 100 is disposed in the substrate 110, the port 112 of the microcavity 100 can be disposed just about anywhere on or within the substrate 110, depending on the position of other layers or components. The port 112 extends between an inner surface 114 of the microcavity 100 and an outer surface of the microcavity 100, such as the top surface, the side-wall, or even the bottom surface (if accessible) of the microcavity 100. The port 112 can be positioned at the center or off-centered on any of the surfaces 114. The port 112 can extend perpendicular to the inner surface 114 or possibly be tilted with respect to inner surface 114. If the microcavity 100 includes an optional second port, it can be also located and positioned as described above.

A microcavity can be etched in a substrate (e.g., silicon, fused silica, etc.) as follows. A first dielectric material (e.g. silicon dioxide, silicon nitride, etc.) is deposited on the substrate to form a layer that is about 50 nm to 300 nm thick. Next, a sacrificial layer (e.g., molybdenum) with a thickness of 0.5 to 3 microns is deposited on the dielectric layer. A second dielectric layer (e.g. silicon dioxide, silicon nitride) with a thickness of about 50 nm to 300 nm is deposited on the sacrificial layer. A fill hole (e.g., 0.5 to 2 microns square) or array of fill holes is defined photolithographically in the second dielectric layer. The second dielectric layer is etched (e.g., with a dry etch), and the molybdenum sacrificial layer is removed via the fill hole(s), e.g., with hydrogen peroxide etch, to form one or more cavities. Then the cavity or cavities are filled with liquid crystal materials.

FIGS. 1B and 1C show the microcavity 100 in two different stages of a process for creating a photo-alignment layer for liquid crystal materials in the microcavity 100. The first stage of the alignment as shown in FIG. 1B is the microcavity 100 filled with a mixture 130 of reactive mesogen 140 and liquid crystal material 160. At this stage, the inner surface 114 is at least partially coated with an azo dye layer 120 and photoaligned prior to the introducing of the mixture 130 into the microcavity 100. The single entry/exit port 112 is shown capped with a capping layer 190, which may be formed by spinning on CYTP (perofluoropolymer) or defined through photolithography.

The azo dye layer 120 includes oblong azo dye molecules aligned in a particular direction (e.g., into and out of the page). Suitable materials for the azo dye layer 120 include, but are not limited to Brilliant Yellow. Without being restrictive, sulphonic azo dyes are particularly suited for this type of photoalignment. Other suitable dyes include SD1 and Chrysophenine.

The azo dye layer 120 was first photoaligned and the thickness obtained after alignment ranges from about 1 nm to about 10 nm (e.g., about 1 nm, about 2 nm, about 3 nm, about 4 nm, about 5 nm, about 6 nm, about 7 nm, about 8 nm, about 9 nm, or about 10 nm). In some embodiments, the azo dye layer has a thickness of less than or equal to about 3 nm, including from about 0.5 nm to about 3 nm, from about 1 nm to about 3 nm, from about 1.5 nm to about 3 nm, from about 2 nm to about 3 nm, and from about 2.5 nm to about 3 nm.

Likewise, the reactive mesogen 140 can be any reactive mesogen, including but not limited to RM257, RM84, etc. Similarly, the liquid crystal 160 used in this experiment is an exemplary material and it can be any other liquid crystal material including, but not limited to liquid crystal materials for which the reactive mesogen is sufficiently insoluble so as to separate at the substrate surface (e.g., when not applying a voltage). In this stage, the reactive mesogen 140 and the LC 160 are mixed to form the mixture 130, then infiltrated into the entire microcavity 100. The capping layer 190 can include, but is not limited to CYTOP, silicon dioxide, etc.

The second stage of the photoalignment process as shown in FIG. 1C is the microcavity 100 filled with the materials shown in FIG. 1B. In FIG. 1C, however, the reactive mesogen 140 has been “photo-processed” to achieve the desired materials properties after certain processes, and the details of these fabrication processes will be further described in the following section. More specifically, in the process stage as shown in FIG. 1C, the reactive mesogen 140 has been separated to localize near the interface of the azo dye layer 120 and polymerized to form a polymerized reactive mesogen layer 142, which is aligned to the azo dye layer 120. The thickness of the polymerized reactive mesogen layer 142 can range from about 1 nm to about 100 nm (e.g., about 1 nm, about 2 nm, about 3 nm, about 4 nm, about 5 nm, about 6 nm, about 7 nm, about 8 nm, about 9 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 100 nm). The remaining LC material 160 now occupies the rest of the microcavity 110 and is aligned to the polymerized reactive mesogen layer 142.

FIG. 1D is a top view of the microcavity 100, which shows a top view of the entirety of the microcavity 100 disposed inside the substrate 110 with the inner most circle representing the single entry/exit port 112.

FIG. 1E is another exemplary embodiment of the microcavity 100 in a different environment. Whereas FIGS. 1A-1D show the microcavity 100 disposed within the substrate 110, FIG. 1E shows an exemplary embodiment in which the microcavity 100 is supported above a substrate 115 by several thermal legs 117. The thermal legs 117 provide thermal and electrical isolation of the microcavity 100 from the substrate 115.

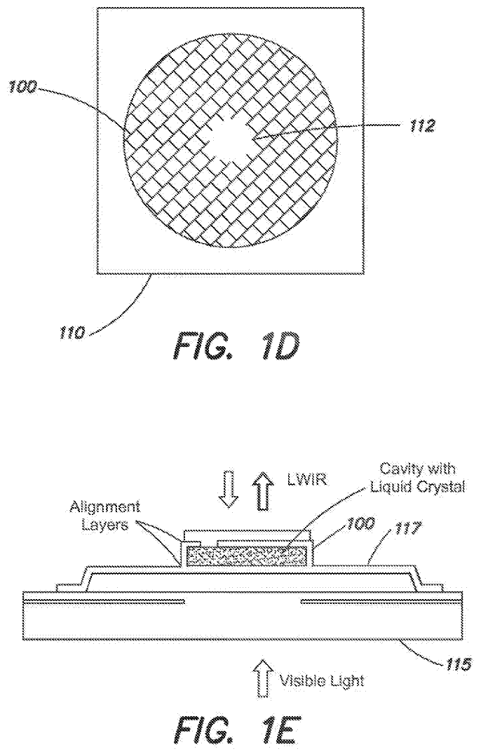

FIG. 2A shows an exemplary fabrication process flow for using reactive mesogen to stabilize photoalignment in a microcavity. The first step 200a in the fabrication process is the creation of a microcavity with a single entry/exit port. Once the microcavity with a single entry/exit port is obtained, an anisotropic dye, such as an azo dye, can be infused into the microcavity so as to coat the interior surface of the microcavity with the anisotropic dye in process step 222a. In step 224a, the anisotropic dye is illuminated with linearly or elliptically polarized light so as to align the anisotropic dye with respect to the interior surface of the microcavity. In step 256a, reactive mesogen and liquid crystal materials are infused into the microcavity. In step 258a, the reactive mesogen is allowed to separate from the liquid crystal material. This can be accomplished by storing the microcavity in the dark (to prevent photo-degradation of the azo dye layer) until the reactive mesogen has accumulated on the azo dye layer. Step 280a in this fabrication process is to illuminate the layer of reactive mesogen at a wavelength selected to cause polymerization of the layer of reactive mesogen material so as to form a layer of polymerized reactive mesogen between, and aligned with, the anisotropic dye layer and the liquid crystal material. In other words, the polymerized reactive mesogen aligns the liquid crystal material to the anisotropic dye layer. Finally, the cell is bleached to eliminate the ability of the azodye film to reorient beneath the polymer layer 290a.

FIG. 2B shows another exemplary fabrication process flow for using reactive mesogen to stabilize photoalignment in a microcavity. In this process, the first step 200b also starts with creation of a microcavity with a single entry/exit port. In step 222b, which is similar to step 222a of the process shown in FIG. 2A, once the microcavity with a single entry/exit port is obtained, an anisotropic dye, such as an azo dye, is infused into the microcavity so as to coat the interior surface of the microcavity with the anisotropic dye. In step 224b, the anisotropic dye is then illuminated with a polarized light so as to form a layer of anisotropic dye aligned with respect to the interior surface of the microcavity. In step 246b, the reactive mesogen is infused into the microcavity. This step is different from step 256a (FIG. 2A) in that it includes infusion of the reactive mesogen without any liquid crystal material whereas step 256a instructs to infuse both the reactive mesogen and the liquid crystal material. Following step 246b is step 268b, which involves infusing liquid crystal material into the microcavity after infusing the reactive mesogen in the step 246b. Since infusing the reactive mesogen separately into the microcavity allows direct localization of reactive mesogen onto the underlying anisotropic dye, there is no need to allow the reactive mesogen to separate from the LC material. After all the materials have been infused into the microcavity, the microcavity is illuminated in step 280b so that the reactive mesogen polymerizes to form an alignment layer that aligns the liquid crystal to the azo dye layer. Finally, the cell is bleached to lock in the desired alignment 290b.

FIG. 2C illustrates a process of creating a stable azo dye photoalignment layer in confined microcavities in greater detail. The first step 200c in the fabrication process is the creation of a microcavity with a single entry/exit port. Brilliant Yellow (BY) dye is mixed into anhydrous N,N-dimethylformamide at 0.5% by weight. For example, the mixture may be vortexed for one minute to create a uniform dye solution. The microcavity is then submerged in this dye solution and allowed to soak, e.g., for 15 minutes (step 222c). Once removed from the dye solution, the top surfaces of the microcavity are cleaned and immediately baked at 150° C. for at least 15 minutes to evaporate solvent out of the microcavity (step 223c). In step 224c, the azo dye is illuminated with blue or UV light (e.g., with a Royal Blue LED with a central wavelength of 447 nm). The intensity of this light at the sample surface may be about 50 mW/cm² and the irradiation time may be at least 5 minutes.

FIG. 2D is a plot of the absorption spectrum of Brilliant Yellow azo dye. Brilliant Yellow has a somewhat wide absorption spectrum which allows for reorientation utilizing wavelengths ranging from high UV (such as 365 nm) or blue light, as shown in FIG. 2D. As a result, the azo dye absorbs relatively strongly in step 224c of the process shown in FIG. 2C.

The fabrication process described in FIG. 2E is an exemplary processing method for infusing reactive mesogen into microcavities. Step 256e of the process begins with creating a mixture of reactive mesogen (e.g., RM257 mixed with 10% wt of photoinitiator, such as Irgacure 651) in liquid crystal BL006. The reactive mesogen/photoinitiator mixture was either 0.9% wt, 1.2% wt, or 1.5% wt in the LC BL006. In step 257e, this mixture is heated to 125° C., then vortexed for 3 minutes to create a somewhat uniform mixture. Note that a 1.5% wt of mixture can be used for a 2-μm thick microcavity and a 3.0% wt of mixture can be used for a 5-μm thick microcavity. Generally, the percentage of reactive mesogen should be low enough to avoid undesired light scattering and high enough so as to stabilize the surface. After vortexing, the mixture is infused into the microcavity and allowed to cool. The microcavity is then stored (e.g., in a dark, airtight container overnight) to allow phase separation of the reactive mesogen to the cell surfaces in step 259e of FIG. 2E. In step 280e, the cells are polymerized by exposure to an unpolarized Mightex high power UV LED source (365 nm) at 3.5 mW/cm². This results in a polymerized reactive mesogen layer on the substrate surfaces that is thin enough not to scatter incident light. Finally, the cell is bleached to lock-in the desired alignment 290e.

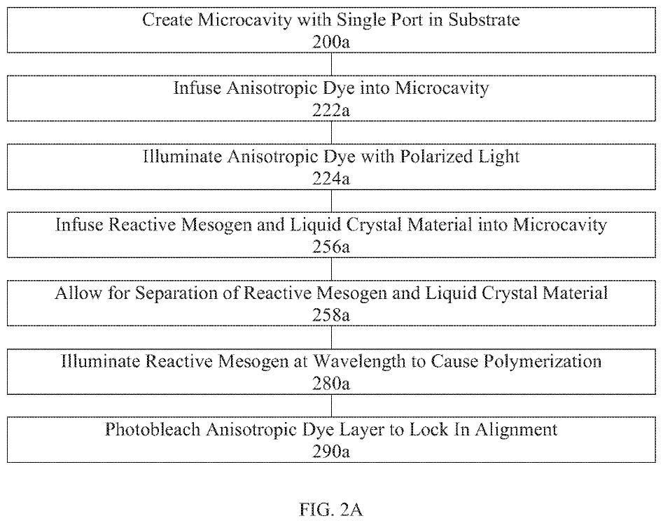

FIG. 3 is a flow chart illustrating an exemplary method in accordance with some embodiments of the present disclosure. The method includes creating a cavity (e.g., a microcavity with a single port) in a substrate 300, infusing an anisotropic dye into the cavity 322, illuminating the anisotropic dye with polarized light to align the anisotropic dye with respect to the surface of the cavity 324, infusing a reactive mesogen and a liquid crystal material into the cavity to align the liquid crystal material with the anisotropic dye 356, storing in conditions wherein the composition will not react in order to allow the reactive mesogen and liquid crystal material to separate 358, illuminating the layer of reactive mesogen at a wavelength selected to polymerize the reactive mesogen to form an alignment layer 380, and bleaching the anisotropic dye layer to lock in the alignment 390.

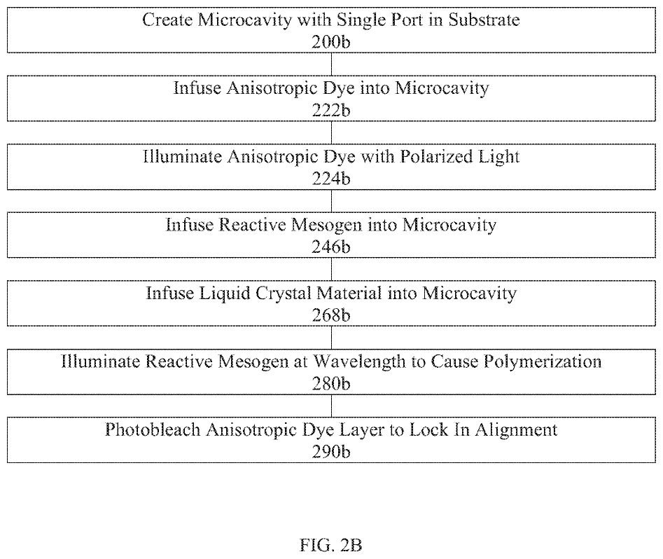

The preferred director, nₒ, is determined by the director orientation at the time of polymerization, where the orientation is imprinted onto the polymer network, illustrated in FIGS. 4A-4D and explained below. If the sample is polymerized (e.g., by exposure to UV light) with no applied voltage, then the polymer network will lock in a planar orientation. However, if a voltage is applied during the polymerization process, then the tilted director configuration will be locked in, even after the voltage has been turned off.

FIG. 4A shows a microcavity 400 within the substrate 410 filled with photoaligned azo dye (not shown) and a mixture 430 of reactive mesogen 440 and LC 460. As shown in FIG. 3A, a thin layer of reactive mesogen 440 has localized closer to the inner surfaces 414 of the microcavity 400, leaving the LC 460 in the bulk of the microcavity 400.

FIG. 4B shows the microcavity 400 under an applied electric field 470. In this stage, the LC 460 molecules in the bulk (center) portion of the microcavity 400 align with the applied polarizing electric field 470, although the orientation of the LC 460 molecules close to or intermixed with the reactive mesogen 440 concentrated near the inner surfaces 414 may remain unchanged. The reactive mesogen 440 (and possibly some LC 460) closer to the inner surfaces 414 remains aligned with the photoaligned azo dye (not shown).

FIG. 4C shows the microcavity 400 under UV illumination 480. In this stage, the UV illumination 480 causes the reactive mesogen 440 molecules polymerize, forming a polymerized reactive mesogen layer 442 that locks-in the orientation of the LC 460 molecules intermixed within its network.

FIG. 4D shows the microcavity 400 after the applied electric field 470 and UV illumination 480 are removed. It shows microcavity 400 with LC 460 aligned to the polymerized reactive mesogen layer 442.

A technique to generate a stable alignment utilizing a photodefinable dye and a surface-localized polymer layer has been described herein. This alignment technique is especially useful for LC applications in uniquely challenging geometry, including microcavities in photonic devices like LC thermal imagers. It has been successfully shown that a non-degrading photoalignment layer can be infused into these fully fabricated microcavities.

A low cost, robust liquid crystal alignment layer whose alignment direction and stabilization can be done after a cell or cavity is created, is demonstrated. The method can be used even if only one entry point to the cavity is available. The procedure does not require any special coating processes such as spin coating, and does not require a high temperature bake or the difficult rub process needed for the common polyimide alignment layers.

One aspect of the disclosed methods is the stabilization of a photoaligned azo dye layer with an ultrathin reactive mesogen that layer that forms without special process steps. Surprisingly, a very small amount of reactive mesogen, mixed with the liquid crystal, may have a very significant effect on the stability of the azo dye layer. It has been demonstrated that this surface-polymer-stabilized photoalignment layer exhibits incredibly high resilience to light exposure (and is thermally stable even without the polymer-stabilization layer).

The methods described herein have a number of benefits. Stable photoalignment layers may be prepared exclusively using commercially available materials, without complicated or expensive process steps. Additionally, the robust photoalignment layer created with polarized light exposure is able to survive subsequent photoexposure for the polymerization of the reactive mesogen layer. Thus, the methods reduce the necessity for strict process control and can even allow for the use of the same exposure setup for both the patterning of the alignment layer, and the polymer stabilization of it.

The polymer-stabilization layer can be introduced into the microcavities by mixing it with the liquid crystals at low weight concentration. A polymer layer introduced into a cell in this manner is able to naturally localize in a thin region near the substrate surfaces. This layer significantly improves the robustness of the alignment against subsequent light exposure, regardless of any degradation of the underlying photoalignment layer. The alignment process described in this here offers versatile ways to expand the field of liquid crystal photonic devices.

The following examples are provided to illustrate the devices and methods of the present disclosure. The examples are merely illustrative and are not intended to limit the disclosure to the materials, conditions, or process parameters set forth therein.

### Examples

A mixture of 0.1% BY was dissolved in DMF by weight and filtered through a 0.2 μm PTFE filter. This mixture was then spun down onto glass substrates at 1500 rpm for 30 seconds. Optionally, the spinning process can be eliminated at this step by infusing the dye solution into the assembled cell or by a dip-coating process. Following spin coating, the substrates were allowed to bake at 120° C. for 10 minutes to allow for evaporation of remaining solvent. BY films were then aligned by exposure to linearly polarized 435 nm light at an intensity of 25 mW/cm² for 5 minutes. Substrates were then assembled into 5 μm thick cells so that they would give planar alignment of the liquid crystal.

Next a mixture of 1.5% RM 257 by weight was dissolved into liquid crystal mixture E7. Cells were then filled at 80° C. under vacuum with the RM 257-E7 mixture so that the liquid crystal was in the isotropic phase. Following filling, the cells were allowed to sit in a dark environment for 1 hour to allow the RM 257 monomer to separate to the surface of the substrates. At this point the entire cell was exposed to 365 nm light at an intensity of 3.5 mW/cm² to polymerize the RM 257.

Next a mixture of 0.3% RM 257 by weight was dissolved into liquid crystal mixture ZLI-4792. Cells were then filled at 120° C. under vacuum with the RM 257-ZLI-4792 mixture so that the liquid crystal was in the isotropic phase. Following filling, the cells were allowed to sit in a dark environment for 1 hour to allow the RM 257 monomer to separate to the surface of the substrates. At this point the entire cell was exposed to 365 nm light at an intensity of 3.5 mW/cm2 to polymerize the RM 257.

Next a mixture of 0.3% RM pictured in FIG. 11 by weight was dissolved into liquid crystal mixture ZLI-4792. Cells were then filled at 120° C. under vacuum with the RM-ZLI-4792 mixture so that the liquid crystal was in the isotropic phase. Following filling, the cells were allowed to sit in a dark environment for 1 hour to allow the RM monomer to separate to the surface of the substrates. At this point the entire cell was exposed to 365 nm light at an intensity of 3.5 mW/cm2 to polymerize the RM.

Finally, the cell was exposed to 435 nm light at an intensity of greater than 200 mW/cm² for 48 hours to bleach the underlying BY film. The result was a liquid crystal cell aligned by the RM 257 layer which is not sensitive to subsequent exposures to polarized light. The polarization sensitivity of the underlying BY film was ‘erased’ by bleaching the dye.

In this way, the process can be broken down into three exposure steps. First, the ‘alignment exposure’ which determines the alignment direction of the BY film. Second, the ‘polymerization exposure’ which polymerizes the surface localized RM 257 layer. Third, the ‘bleaching exposure’ which eliminates the polarization sensitivity of the underlying BY film.

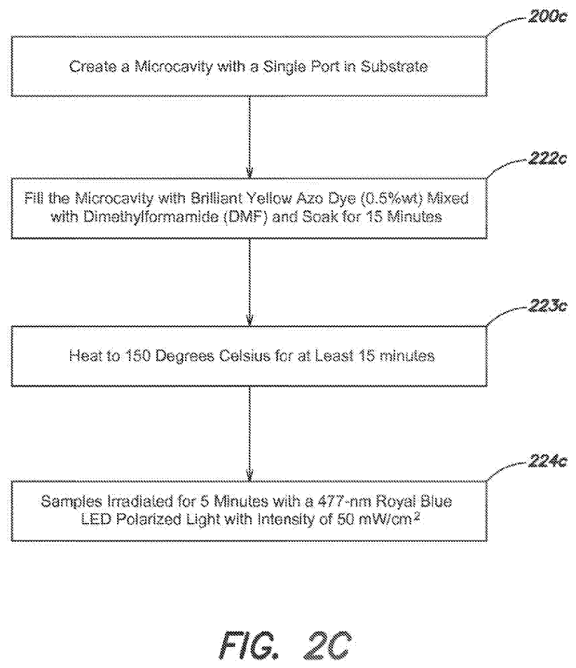

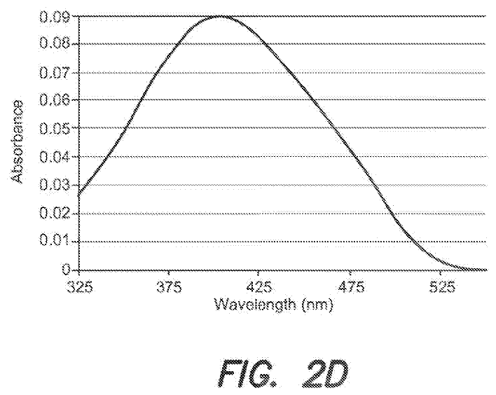

Photostability of the cells produced was checked by exposing them to 435 nm light polarized 45 degrees with respect to the alignment axis of the cell at an intensity of 10 mW/cm². Initially, the ‘alignment’ and ‘polymerization’ exposures were performed without the ‘bleaching’ exposure. Cells made in this manner showed stable alignment for as long as one month of continued exposure to the photostability test as described above (FIG. 5). However, cells which had seen photostability testing for days were dismantled so that the alignment of the BY film on each substrate could be determined. By collecting polarized absorbance data at various angles, a probability distribution of the in-plane orientation of the BY molecules was constructed before and after photostability testing (FIG. 6). Interestingly, the BY molecules had a new preferred direction of alignment about 45 degrees with respect to the original direction. This meant that the BY was still free to reorient beneath the reactive mesogen. As long as this reorientation was possible, questions remain about the long term stability of the samples.

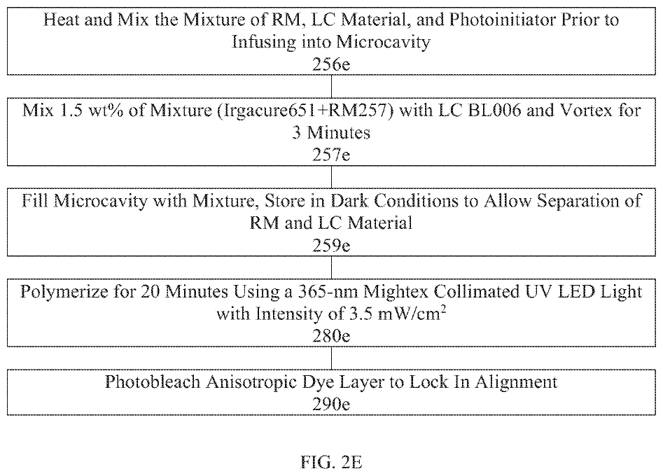

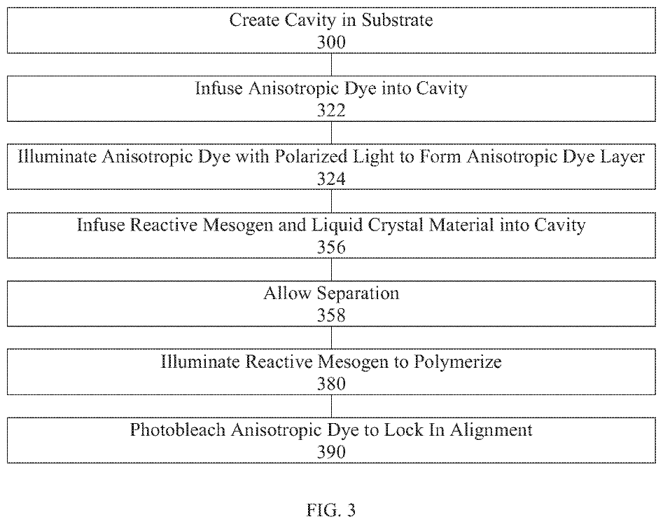

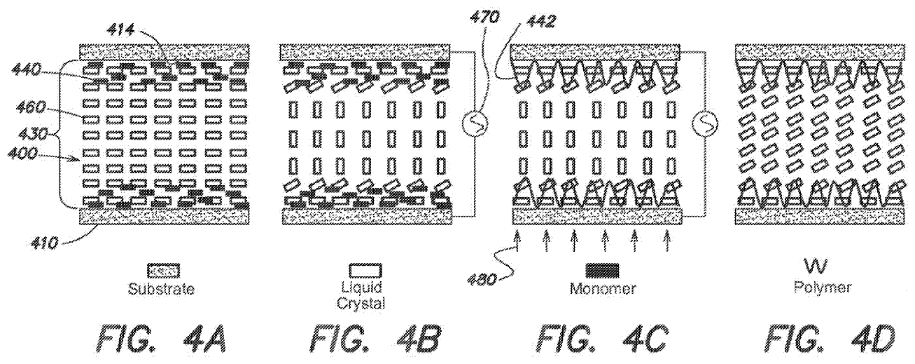

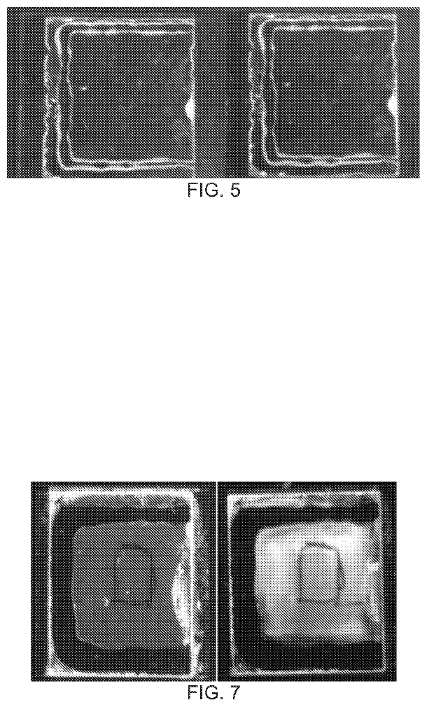

Bleaching of the dye layer was accomplished by a 48 hour exposure to very intense (>200 mw/cm²) unpolarized light at 435 nm. A cell filled with pure E7 was made as a control along with a cell filled with a mixture of RM 257 and E7. After 48 hours of exposure, the control cell showed a completely destroyed alignment—when viewed between crossed polarizers, no uniform dark state was present (FIG. 7). Conversely, after 48 hours, the RM 257 stabilized cell appeared to retain its original alignment when viewed between crossed polarizers (FIG. 8). To ensure that there was no induced pretilt in the liquid crystal director, transmission vs viewing angle measurements were collected before and after the ‘bleaching’ exposure (FIG. 9). These measurements showed that the transmission vs voltage curves were symmetric about normal incidence before and after the 48 hour exposure indicating no change or generation of pretilt. Finally, cells were dismantled so that polarized absorbance measurements could be collected (FIG. 10). Prior to bleaching there was a large difference between the absorbance along the preferred alignment axis and perpendicular to it resulting in a very high dye order parameter of 0.82. After bleaching, however, there was very little difference between the absorbance along different polarizations. Additionally, the magnitude of the absorbance at the maximum band of the dye (˜408 nm) is infinitesimal. Since the ability of the dye layer to absorb light has been eliminated, there are no questions about a change in dye orientation and subsequent change in liquid crystal orientation. The result is a stable RM 257 alignment layer.

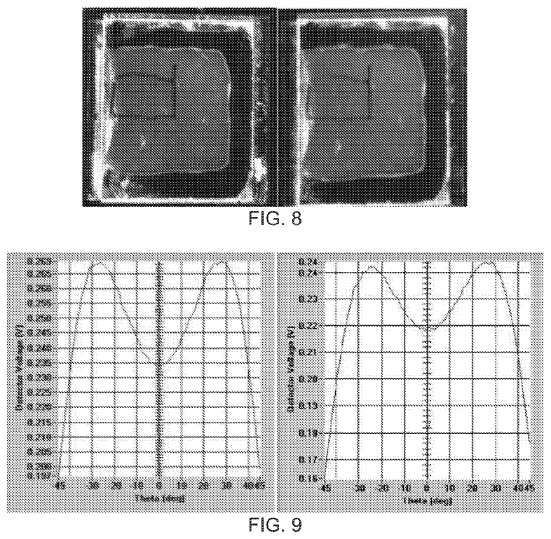

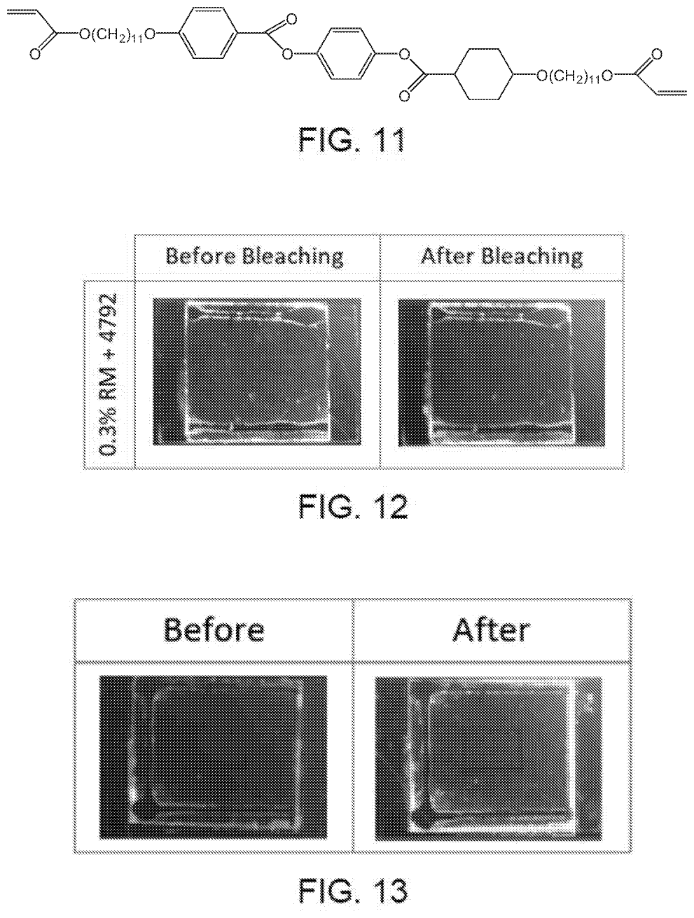

FIGS. 12 and 13 are similar to FIG. 8 but show cells with other mixtures before and after bleaching. In FIG. 12, the cell contained 0.3% by weight RM 257 in ZLI-4792. In FIG. 13, the cell contained 0.3% by weight of the reactive mesogen of FIG. 11 in ZLI-4792.

Regarding the lifetest results for the cells pictured in FIGS. 5, 7, 8, 12, and 13, the photo-stability of the RM alignment film is determined by observing the dark state of the LC cell between crossed polarizers before and after exposure to light polarized at 45° with respect to the original alignment axis. The ‘dark’ state of a LC cell with uniform planar alignment is observed when the LC alignment axis coincides with the transmission axis of either the analyzer or polarizer. When azodyes are exposed to polarized light they tend to reorient so that their long axis is perpendicular to the polarization axis. Therefore, when a LC sample aligned by azodyes is exposed to light polarized at 45° to its alignment axis, it is expected that the configuration necessary to achieve the dark state is also rotated by 45°. It has been demonstrated that RM-stabilized samples can survive at least one month of exposure to polarized light without any change in the dark state observed. Samples were observed between crossed polarizers and a spatially uniform dark state was observable for the same angle between original alignment axis and transmission axis of the polarizer before and after exposure to polarized light (FIG. 5). Through polarized absorbance spectra (FIG. 6) it has been shown that the RM provides a stable liquid-crystal alignment, but the underlying azodye film is still free to change its alignment axis. In order to eliminate the ability of the azodye film to reorient it was considered to eliminate the polarization sensitivity of the absorbance of the dye film by exposure to unpolarized light at a high intensity. Upon exposure to unpolarized light, azodyes tend to orient themselves out of plane to be parallel to the propagation direction of the incident light. The results of exposure to unpolarized light have been determined for cells both with and without RM stabilization. After exposure, samples filled with pure LC (no RM) did not exhibit a spatially-uniform dark state for any angle between the original alignment axis and transmission axis of polarizer; this indicates a random orientation of the LC molecules (FIG. 7). Samples that were filled with an RM and LC mixture, however, exhibited a uniform dark state for the same angle between alignment and polarizer axis before and after exposure to unpolarized light (FIGS. 8, 12, and 13). These samples were then dismantled and polarized absorbance spectra were collected from each substrate. It was shown that the overall magnitude of the film absorption was decreased and that the polarization sensitivity of the absorbance spectrum was eliminated (FIG. 10).

Overall these tests demonstrate multiple beneficial properties of the RM stabilization process. First, the tests with exposure to polarized light demonstrate the photo-stability of the liquid crystal alignment. Second, the polarized absorbance spectrum collected from these samples show that the azodye film is free to change its alignment axis underneath the RM film. This means the surface localized RM layer has replaced the azodye as the LC alignment layer. Third, polarized absorbance spectrum collected after exposure to unpolarized light demonstrate that the polarization sensitivity of the dye-film's absorbance can be eliminated which prevents further reorientation of the azodye film.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A method of aligning a liquid crystal material to an inner surface of a microcavity, the method comprising:
infusing an anisotropic dye into the microcavity so as to coat the interior surface of the microcavity with the anisotropic dye;
illuminating the anisotropic dye with polarized light so as to form an anisotropic dye layer aligned with respect to the inner surface of the microcavity;
infusing a reactive mesogen and the liquid crystal material into the microcavity;
illuminating the reactive mesogen at a wavelength selected to cause polymerization of the layer of reactive mesogen so as to form a polymerized reactive mesogen layer;
aligning the liquid crystal material with respect to the anisotropic dye layer; and
bleaching the anisotropic dye layer.

2. The method of claim 1, wherein infusing the anisotropic dye comprises infusing at least one of an azo dye or a dye substantially similar to an azo compound.

3. The method of claim 1, wherein infusing the anisotropic dye comprises: disposing the microcavity in a dye solution comprising the anisotropic dye and a solvent; and heating the microcavity so as to evaporate the solvent.

4. The method of claim 1, wherein the reactive mesogen comprises infusing RM257.

5. The method of claim 1, wherein infusing the reactive mesogen and the liquid crystal material comprises: infusing a mixture of the reactive mesogen, the liquid crystal material, and a photoinitiator into the microcavity.

6. The method of claim 5, wherein the mixture of the reactive mesogen, the liquid crystal material, and the photoinitiator has a weight ratio of reactive mesogen to liquid crystal material to photoinitiator of:
about 1.35 to about 98.50 to about 0.15; or
about 0.3 to about 99.55 to about 0.15.

7. The method of claim 5, further comprising:
heating and mixing the mixture of the reactive mesogen, the liquid crystal material, and the photoinitiator prior to infusing the mixture into the microcavity.

8. The method of claim 7, wherein infusing the reactive mesogen and the liquid crystal material further comprises: allowing the reactive mesogen to separate from the liquid crystal material before illuminating the reactive mesogen.

9. The method of claim 1, wherein illuminating the reactive mesogen further comprises: applying at least one voltage across at least a portion of the microcavity while illuminating the reactive mesogen so as to lock in alignment of the polymerized reactive mesogen layer with respect to the anisotropic dye layer.

10. The method of claim 1, wherein applying the at least one voltage comprises: applying a first voltage across a first portion of the microcavity and a second voltage across a second portion of the microcavity so as to create spatially varying alignment of the anisotropic dye to the liquid crystal material.

11. The method of claim 1, wherein the polymerized reactive mesogen layer has a thickness of less than approximately 100 nanometers or less than approximately 10 nanometers.

12. The method of claim 1, further comprising:
infusing a photoinitiator into the microcavity before illuminating the reactive mesogen with ultraviolet light.

13. The method of claim 12, wherein the photoinitiator comprises Irgacure 651.

14. The method of claim 1, wherein the anisotropic dye layer has a thickness of about 3 nanometers.

15. The method of claim 1, wherein the bleaching is performed by exposing the anisotropic dye layer to light at an intensity of at least 150 mW/cm².

16. The method of claim 1, wherein the bleaching is performed by exposing the anisotropic dye layer to light at an intensity of at least 200 mW/cm².

17. The method of claim 1, wherein the bleaching is performed by exposing the anisotropic dye layer to high intensity light for a duration of at least 36 hours.

18. The method of claim 1, wherein the bleaching is performed by exposing the anisotropic dye layer to high intensity light for a duration of at least 48 hours.

19. A method of aligning a liquid crystal material to an inner surface of a microcavity, the method comprising:
infusing an anisotropic dye into the microcavity so as to coat the interior surface of the microcavity with the anisotropic dye;
illuminating the anisotropic dye with polarized light so as to form an anisotropic dye layer aligned with respect to the inner surface of the microcavity;
infusing a reactive mesogen and the liquid crystal material into the microcavity;
illuminating the reactive mesogen at a wavelength selected to cause polymerization of the layer of reactive mesogen so as to form a polymerized reactive mesogen layer;
aligning the liquid crystal material with respect to the anisotropic dye layer; and
bleaching the anisotropic dye layer;
wherein the bleaching is performed by exposing the anisotropic dye layer to light at an intensity of at least 150 mW/cm²; and
wherein the bleaching is performed by exposing the anisotropic dye layer to high intensity light for a duration of at least 36 hours.

20. A method of aligning a liquid crystal material to an inner surface of a microcavity, the method comprising:
infusing an anisotropic dye into the microcavity so as to coat the interior surface of the microcavity with the anisotropic dye;
illuminating the anisotropic dye with polarized light so as to form an anisotropic dye layer aligned with respect to the inner surface of the microcavity;
infusing a reactive mesogen and the liquid crystal material into the microcavity;
illuminating the reactive mesogen at a wavelength selected to cause polymerization of the layer of reactive mesogen so as to form a polymerized reactive mesogen layer;
aligning the liquid crystal material with respect to the anisotropic dye layer; and
bleaching the anisotropic dye layer;
wherein the bleaching is performed by exposing the anisotropic dye layer to light at an intensity of at least 200 mW/cm²; and
wherein the bleaching is performed by exposing the anisotropic dye layer to high intensity light for a duration of at least 48 hours.
